(19) United States
(12) Patent Application Publication
(10) Pub. No.: US 2009/0055341 A1
(43) Pub. Date: Feb. 26, 2009

(54) Regulatory Survey Automation System (RSAS)

(75) Inventors: Prashant BIDKAR, Delhi (IN); Vinay Kumar, New Delhi (IN); Mamta Mittal, Haryana (IN); Pankaj Poddar, Delhi (IN); Ritu Pahuja, Delhi (IN)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 12/126,755

(22) Filed: May 23, 2008

(30) Foreign Application Priority Data
Aug. 22, 2007 (IN) 1791/DEL/2007

(51) Int. Cl. G06N 5/02; G06F 7/06; G06F 17/30; G06F 15/16

(52) U.S. Cl. 706/47; 707/4; 709/202; 707/E17.014

(57) ABSTRACT

The present invention provides a system, method and computer program product for generating automated reports. Input data from various spreadsheets is consolidated. Thereafter, based on the input data, a set of output values are determined. The output values are then updated in a form that serves as a template for the report. Subsequently, the form is submitted to a recipient.

### CROSS-REFERENCE TO RELATED APPLICATIONS

This application claims benefit under 35 U.S.C. §119(a)-(d) to Indian Provisional Patent Application No. 1791/DEL/2007, filed Aug. 22, 2007, which is incorporated by reference herein in its entirety.

### BACKGROUND

1. Field

The invention relates to the field of computer-based business systems and, more particularly systems for generating automated reports.

2. Related Art

Corporations are often required to report information to various governmental agencies. For example, a corporation may be responsible for reporting the financial positions of its foreign affiliates to the U.S. Bureau of Economic Analysis. Such reporting is done in the form of surveys submitted in compliance with external regulations. For example, a government agency may have a specific form which needs to be filled by a corporation, with the required figures from a report.

Usually, input data that needs to be entered in a form is consolidated manually. The input data may be present in a large number of spreadsheets and files. However, due to voluminous size of the input data, the process of consolidation of the input data can be quite complex and error prone. Further, certain control weaknesses exist during the consolidation of the input data, due to numerous spreadsheet linkages and multiple files. Moreover, the manual process of consolidation of the input data involves extensive time and resources. Further, such manual process lacks audit trail for changes made by different users during various stages

In addition, external regulations undergo periodic changes that require corresponding changes in the input data consolidation process. Changes in the process are often cumbersome as the reviewers are obligated to analyze and review the input data in a short span of time. Further, a team may face problems to give a variance explanation to a government agency with respect to the last filings wherever required.

Furthermore, calculations to determine final reportable figures that need to be entered in a form are done manually or are based on Microsoft Excel®-based formulae and linking sheets. Filling and filing of the forms is also often done manually. Such processes lack sufficient control, are time consuming, are prone to errors due to their manual intensive nature, and lack audit trails.

### SUMMARY

In an embodiment, the present invention includes an automated report-generating system. The automated report-generating system may include a database configured to store input data, an input module configured to consolidate the input data, a computation module configured to determine a set of output values based on the input data according to a predefined rule, and an output module configured to compile at least one form with the set of output values. The at least one form is compliant with a predefined format for submission to a recipient.

In another embodiment, the present invention includes a method for automatic report generation. In an embodiment, input data stored in a database is consolidated based on a set of keywords. The input data is received from a plurality of sources. A set of output values to be entered into a form is determined according to a predefined rule, the set of output values being based on the consolidated input data. After the form is updated with the set of output values. the updated form is converted to a format compatible with a recipient. In an embodiment, a computer program product for implementing such a method is also included.

Further embodiments, features, and advantages of the present invention, as well as the structure and operation of the various embodiments of the present invention, are described in detail below with reference to the accompanying drawings.

### BRIEF DESCRIPTION OF THE DRAWINGS

The features and advantages of the present invention will become clearer from the detailed description set forth below, when taken in conjunction with the drawings, in which like reference numbers indicate identical or functionally similar elements. Additionally, the digit on the extreme left of a reference number identifies the drawing in which the reference number first appears.

FIG. 1 is a block diagram of an automated report-generating system, in accordance with various embodiments of the present invention.

FIG. 2 is a block diagram of an input module, used in an automated report-generating module, in accordance with an embodiment of the present invention.

FIG. 3 is a block diagram of a computation module, used in an automated report-generating module, in accordance with an embodiment of the present invention.

FIG. 4 is a block diagram of an output module, used in an automated report-generating module, in accordance with an embodiment of the present invention.

FIG. 5 is a flowchart illustrating a process for generating automated reports, in accordance with an embodiment of the present invention.

FIGS. 6a and 6b are a flowchart illustrating a process for generating automated reports, in accordance with another embodiment of the present invention.

FIG. 7 is an exemplary screenshot generated by the user interface of an automated report-generating system, in accordance with an embodiment of the present invention.

FIG. 8 is an exemplary screenshot generated by the user interface of an automated report-generating system, in accordance with another embodiment of the present invention, is shown.

FIG. 9 is an exemplary screenshot generated by the user interface of an automated report-generating system, in accordance with yet another embodiment of the present invention.

FIG. 10 is a block diagram of an exemplary computer system that is useful for implementing the invention.

### DETAILED DESCRIPTION

### I. System

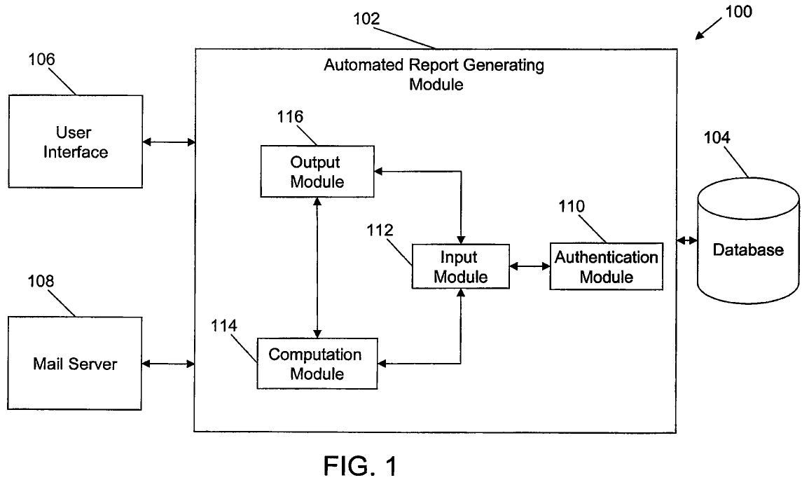

Referring to FIG. 1, a block diagram of an automated report-generating system 100, in which various embodiments of the present invention are implemented, is shown.

Automated report-generating system 100 includes an automated report-generating module 102, a database 104, a user interface 106 and a mail server 108. Automated report-generating module 102 includes an authentication module 110, an input module 112, a computation module 114 and an output module 116. Automated report-generating module 102 generates automated reports, based on the data stored at database 104.

Database 104 stores input data. This input data may include, but is not limited to, data present in Microsoft Excel® files, fixed values, manual values, data present in specific spreadsheets of database 104, and the like. Further, database 104 stores a plurality of forms. Each field in the form in which input data needs to be entered has a predefined cell reference number.

User interface 106 displays information to a user accessing automated report-generating system 100. The information displayed by user interface 106 may include, for example, forms stored in database 104, instructions for filling a form, form properties, the status of the forms, and the like. Further, user interface 106 enables the user to email a particular form, with his comments, to another user by using mail server 108.

Mail server 108 provides a client-server interface for automated report-generating module 102. Mail server 108 may include, for example, an IBM Lotus Notes® Database, (LNDB), a Microsoft Exchange Server (MS Outlook®), or the like.

Authentication module 110 maintains a list of identification names, passwords, and the accessibility options of users who are authorized to access automated report-generating system 100, in, for example, an authentication table. Although reference will be made herein to an embodiment having an authentication table, one of skill in the art will recognize that other means of storing and organizing data may be used without departing from the spirit and scope of the present invention. The authentication table is stored in database 104. The accessibility options of a user may be set as administrator rights or user rights at different levels. Authentication module 110 authenticates a user logging into automated report-generating system 100. In various embodiments of the present invention, authentication module 110 authenticates the user, based on the identification name and password, through user interface 106. Authentication module 110 checks whether the identification name and the password entered by the user are available in the list of identification names and passwords stored in the authentication table. If a match is found, the user is granted access to automated report-generating system 100. However, if a match is not found, the user is denied access to automated report-generating system 100.

Authentication module 110 also configures automated report-generating system 100, based on the accessibility options set for the user. A user with ‘administrator rights’ may have different accessibility options, as compared to a user with ‘user rights’. In various embodiments of the present invention, authentication module 110 may enable the user to edit, add or delete the identification names, passwords and accessibility options of other authorized users through user interface 106. For example, the user with administrator rights may edit, add or delete the identification name, password and accessibility options of another authorized user through user interface 106. However the user with user rights may not be able to edit, add or delete identification name, password, and accessibility options of another authorized user through user interface 106. Authentication module 110 updates the authentication table after edits, additions or deletions have been made. In an embodiment of the present invention, authentication module 110 may prompt the user to change his or her password at regular predefined intervals of time. For example, authentication module 110 may prompt the user to change the password on the first day of every month. This changed password is updated in the authentication table.

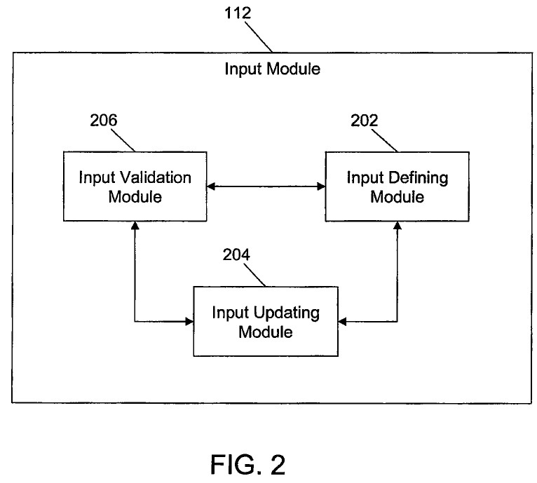

Input module 112 consolidates the input data stored in database 104. Thereafter, computation module 114 determines a set of output values that will be entered in the form. Subsequently, output module 116 submits an electronic copy of the form over at network, such as the Internet, to a recipient. Input module 112, computation module 114 and output module 116 are explained in detail with reference to FIGS. 2, 3 and 4, respectively.

In accordance with various embodiments of the present invention, database 104 may be, for example and without limitation, a Hyperion® database server, a Structured Query Language (SQL) server, an Oracle server, and the like. In various embodiments of the present invention, the backend architecture of automated report-generating module 102, input module 112, computation module 114 and output module 116 can be implemented by using Microsoft Access® tools. User interface 106 may be implemented by using Microsoft Visual Basic® tools.

Referring now to FIG. 2, a block diagram of input module 112 used in automated report-generating module 102, in accordance with an embodiment of the invention, is shown. Input module 112 includes an input defining module 202, an input updating module 204 and an input validation module 206.

Input defining module 202 maintains one or more master detail tables in database 104. These master detail tables include a list of check parameters that correspond to the input data that needs to be consolidated. In various embodiments of the present invention, input defining module 202 can enable the user to edit the check parameters stored in the master detail table through user interface 106, based on the accessibility options set for the user by authentication module 110. For example, a user with administrator rights may edit the check parameters. However, a user with user rights may not be able to do so. Thereafter, input defining module 202 updates the one or more master detail tables after the process of editing of the check parameters is complete.

Input updating module 204 consolidates the input data stored in database 104. Input data may include, for example, but is not limited to, fixed values, manual values, data from database 104-specific spreadsheets, and data from external spreadsheet files, such as Microsoft Excel® files. Fixed values can be stored in a fixed-value-table and may include input variables such as company name, company address and the like. Manual values can be stored in a manual-value table. Manual values are entered by a user through user interface 106 and may include, for example, the number of employees in an organization, the number of markets in a given geography, and the like. Data from external spreadsheet files can be selected through user interface 106 by defining the path to the external spreadsheet files located at database 104. Further, the data can be stored in, for example, an Excel-values table. Similarly, data from database 104-specific spreadsheets can be selected through user interface 106 by defining the path to the database 104-specific spreadsheets located at database 104. Furthermore, the data can be stored in a database values table.

The consolidation of input data by input updating module 204 is based on a set of keywords. A keyword includes the attributes of the input data that must be entered in the form. In an embodiment of the present invention, the keywords are defined by a user with administrative rights. These keywords are stored in a keyword table and are linked to reportable cells in the form. A reportable cell is a reference to a field in the form where the input data needs to be entered after computation. In various embodiments of the present invention, input updating module 204 displays a list of keywords through user interface 106. Input updating module 204 may allow a user to edit, add or delete a keyword through user interface 106, based on the accessibility options set for the user by authentication module 110. However, a user with user rights may not be able to edit, add or delete the keywords. Input updating module 204 updates the keyword table after the keyword has been edited, added or deleted.

Subsequently, input validation module 206 validates the input data to check for errors according to the check parameters in the master detail table. If any portion of the input data is missing, input validation module 206 displays the empty fields corresponding to the missing data through user interface 106, and prompts the user to check the input data stored in database 104. In an embodiment of the present invention, input validation module 206 generates an input-exception report of the input data. The input exception report may be displayed to the user through user interface 106. For example, the user may set threshold values for the input data through user interface 106. The input exception report displays an alert flag against the input data if the value of the input data exceeds a threshold value. Thus, input validation module 206 ensures the completeness of the input data consolidated by input updating module 204.

In accordance with various embodiments of the present invention, database 104 stores the fixed-value table, the manual-value table, the Excel-value table, the database-value table, the keyword table and the master detail table. Database 104 may be, for example, a Hyperion® database server, a Structured Query Language (SQL) server, an Oracle server, and the like. In various embodiments of the present invention, the backend architecture of input module 112, input defining module 202, input updating module 204 and input validation module 206 may be implemented by using Microsoft Access® tools. The user interface 106 may be implemented by using Microsoft Visual Basics tools.

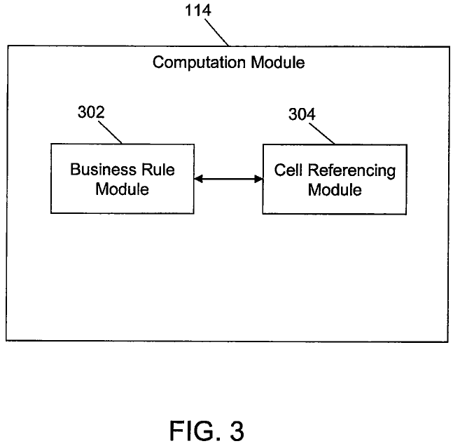

Referring now to FIG. 3, a block diagram of computation module 114 used in automated report-generating module 102, in accordance with an embodiment of the invention, is shown. Computation module 114 includes a business rule module 302 and a cell referencing module 304.

Business rule module 302 determines the set of output values to be entered in the form. A business rule is defined to calculate an output value. Predefined business rules are stored in a business-rule table. A business rule may include, for example and without limitation, an equation, a set of equations, a keyword corresponding to the input data to be entered in an equation, a set of keywords corresponding to the input data to be entered in the equations, a predefined list of mathematical functions, and a predefined list of arithmetic and logical operators. Examples of business rule types include, without limitation, a total gross operating revenue equation, a total assets equation, a total liabilities equation, and a net income equation. In various embodiments of the present invention, a user with administrative rights may select the business rule through user interface 106.

After the selection of the business rule, business rule module 302 executes the selected business rule to calculate the output value. In various embodiments of the present invention, business rule module 302 may allow the user to add or delete a business rule through user interface 106, based on the accessibility options set for the user by authentication module 110. Editing a business rule may include, for example, the addition or deletion of a keyword, the deletion of the existing equation, or building a new equation by using the set of keywords, a predefined list of mathematical functions and a predefined list of arithmetic and logical operators. In various embodiments of the present invention, a user with administrator rights may create, edit or delete the business rules. However, the user with user-rights may not be able to create, edit or delete the business rules. Business rule module 302 updates the business rule table after the addition, editing or deletion of the business rule. In various embodiments of the present invention, business rule module 302 stores the business rule table in database 104.

Cell referencing module 304 references the output values to the reportable cells in the form. Each business rule has a unique identification number. Cell referencing module 304 links the output values with the reportable cells in the form through the unique identification numbers of the business rules. The reportable cell is a field in the form where the output value is displayed.

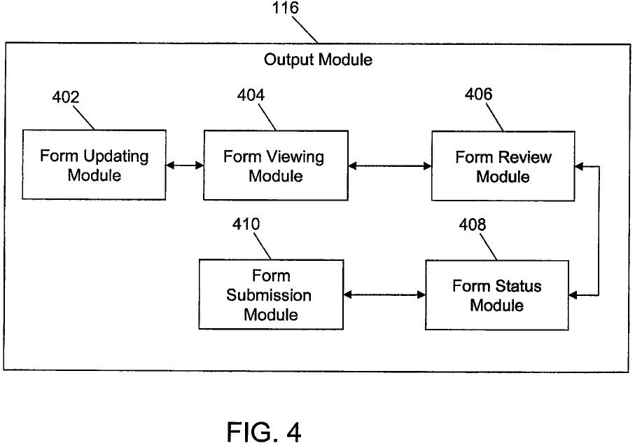

Referring now to FIG. 4, a block diagram of output module 116, used in automated report-generating module 102, in accordance with an embodiment of the invention, is shown. Output module 116 includes a form updating module 402, a form viewing module 404, a form review module 406, a form status module 408 and a form submission module 410.

Form updating module 402 updates the form based on fixed, manual and output values. Fixed values stored in the fixed-value table are automatically entered in the corresponding reportable cells of the form. Manual values stored in the manual-value table are automatically entered in the corresponding reportable cells of the form. Similarly, output values determined by business rule module 302 are automatically entered in the corresponding reportable cells of the form. In various embodiments of the present invention, the user can instruct form updating module 402 to update the form through user interface 106.

Form viewing module 404 displays the form that has been updated with all the required output values through user interface 106. The form can be printed by using a printer, mailed through mail server 108, saved as an image file, copied to a clipboard, and so forth.

Thereafter, form review module 406 enables the user to review the form. The user can add comments to the reviewed form through user interface 106. In an embodiment of the present invention, form review module 406 generates an exception report for an output value. This exception report can be displayed to the user through user interface 106. For example, the user can set threshold values for the output values through user interface 106. The exception report displays an alert flag against the output value if the output value exceeds the threshold value.

In an embodiment of the present invention, form review module 406 generates a trend-wise report of an output value. This trend-wise report may be displayed to the user through user interface 106. The trend-wise report may include, for example, a tabular comparison of the output value for the current year with the output values for previous years. In another example, the trend-wise report may include a graphical comparison of the output values for the current year with the output values for previous years. A user can select various parameters that will be included in the trend-wise report through user interface 106. The parameters may include, for example, the number of years, variation ratios, and the like.

In another embodiment of the present invention, form review module 406 generates an input-output reconciliation report for the output values. This input-output reconciliation report may be displayed to the user through user interface 106. The input-output reconciliation report displays the output values determined by business rule module 302 and the output values entered in the reportable cells of the form. An error flag is raised if there is a discrepancy between the values.

In yet another embodiment of the present invention, form review module 406 generates a business rule status report to check the validity of a business rule. The user can set an expected value and variance limit for the output values, after the business rule is executed, through user interface 106. An error flag is raised through user interface 106 if the output values do not fall within the set variance limit after the execution of the business rule. In another embodiment of the present invention, form review module 406 generates an audit trail report. This audit trail report displays audit status of the form, through user interface 106. The audit status may include a tabular format of, for example, the stages of review through which the form has passed, the time stamp of the lapsed stage, the name of the reviewer at each stage, and so forth. In various embodiments of the present invention, the user may add a comment to a report generated by form review module 406, through user interface 106. The report can be printed by using a printer, exported to a spreadsheet application, and mailed through mail server 108 to an intended user. In various embodiments of the present invention, the user may approve or reject the reviewed form, based on the reports generated by form review module 406.

Subsequently, form status module 408 generates various reports to track the status of the form. In an embodiment of the present invention, form status module 408 generates a form status report. This form status report displays, through user interface 106, whether the form is reportable or non-reportable. The user can select the number of years to be displayed in the form status report, through user interface 106. In yet another embodiment of the present invention, form status module 408 generates a form log report which can be displayed to the user through user interface 106. In various embodiments of the present invention, the reports generated through form status module 408 can be printed on a printer, mailed through mail server 108 and exported to a spreadsheet application.

Form submission module 410 converts the form into a format that is compatible with a recipient. Additionally, form submission module 410 may encrypt the form. In an embodiment of the present invention, form submission module 410 submits an electronic copy of the form, through mail server 108, to the recipient over a network. In another embodiment of the present invention, the user may manually upload the form on the website of the recipient through user interface 106. In yet another embodiment of the present invention, the user may fax the form to the recipient.

### II. Process

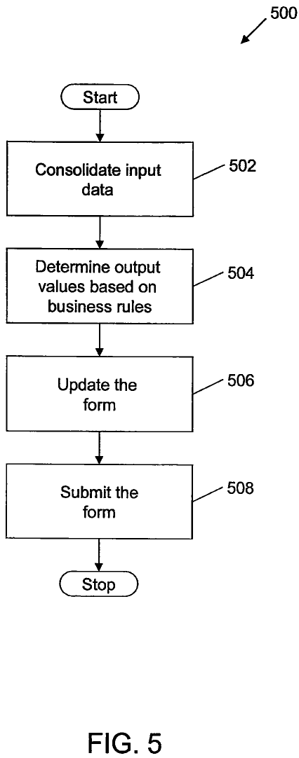

Referring to FIG. 5, a flowchart illustrating a process 500 for generating automated reports, in accordance with an embodiment of the present invention, is shown.

At step 502, input data stored in database 104 is consolidated. The input data may include, but is not limited to, fixed values, manual values, affiliate details, data present in database 104 specific spreadsheets, and data present in other spreadsheet files, such as Microsoft Excels files. Fixed values may include input variables like company name, company address, and the like. Manual values may be entered by the user. Manual values may be stored in the manual value table. Data from external spreadsheet files may be selected by defining the path to the external spreadsheet file located in database 104. Likewise, data from a database-specific spreadsheet may be selected by defining a path to the specific spreadsheet in database 104. In various embodiments of the present invention, user interface 106 may be used to select the input data.

The input data is consolidated based on a set of keywords. The keywords may be defined by the user and stored in the keyword table. In an embodiment, a keyword includes attributes of the input data that are entered in a form. The keyword is linked to reportable cells in the form. In this context, a reportable cell is a reference to a field in the form, where the input data needs to be entered, after computation.

Thereafter, at step 504, a set of output values to be entered in the form are determined. The output values are based on a set of business rules. A business rule may include, for example and without limitation, a set of equations, a set of keywords corresponding to the input data to be entered in the equations, a predefined list of mathematical functions, and a predefined list of arithmetic and logical operators. In various embodiments of the present invention, a user with administrative rights may select a business rule through user interface 106. Each business rule has a unique identification number. Output values are referenced to reportable cells in the form, through the unique identification numbers of the business rules. In this context, a reportable cell is a field in the form where an output value should be displayed. Subsequently, the form is updated, at step 506. The output values determined at step 504 are entered in the corresponding reportable cells of the form. Similarly, fixed values and manual values are entered in the corresponding reportable cells of the form. The form may be displayed to the user on user interface 106.

Finally, at step 508, the form may be converted to a format compatible with a recipient. Thereafter, the form may also be encrypted. In an embodiment of the present invention, an electronic copy of the form is submitted over the internet to the recipient, through mail server 108. In another embodiment of the present invention, the user may manually upload the form on the website of the recipient, through user interface 106. In yet another embodiment of the present invention, the user may fax the form to the recipient. In an embodiment of the present invention, the form may be saved as an image file, copied to a clipboard and printed using a printer.

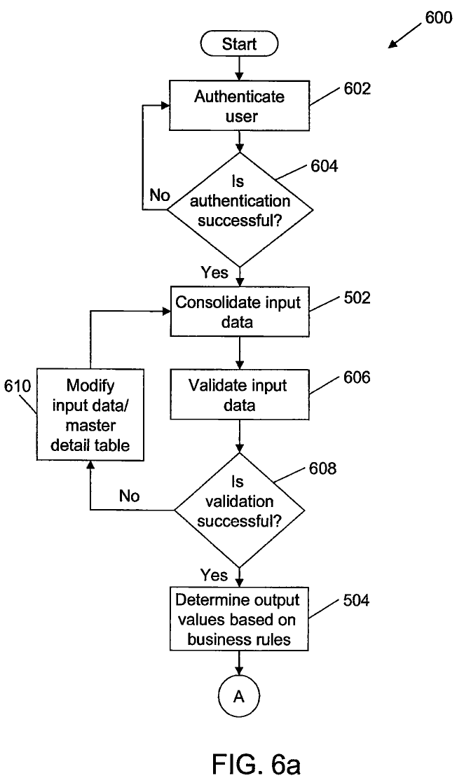

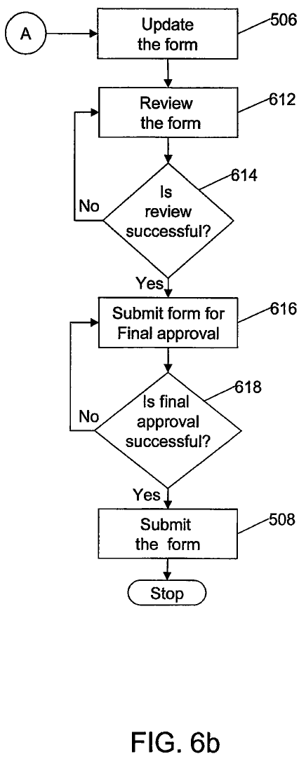

Referring now to FIGS. 6a and 6b, a flowchart illustrating a process 600 for generating automated reports, in accordance with another embodiment of the present invention, is shown.

At step 602, a user logging in to automated report-generating system 100 is authenticated, based on an identification name and password. A list of identification names, passwords, and accessibility options of the users who are authorized to access automated report-generating system 100 is maintained in an authentication table. Thereafter, at step 604, a check is performed to determine whether the identification name and the password entered by the user are available in the list of identification names and passwords stored in the authentication table. If the identification name and the password entered by the user are available in the list of identification names and passwords stored in the authentication table, step 502 is performed.

At step 502, input data is consolidated. Step 502 has been explained in detail in conjunction with FIG. 5. After the consolidation of the data is complete, the validity of the consolidated data is checked at step 606.

At step 606, the input data is validated to check for errors. A master detail table is stored in database 104. The master detail table includes a list of check parameters corresponding to input data that needs to be entered in the form. The input data is checked with respect to the corresponding check parameters from the master detail table. Thereafter, at step 608, it is checked to determine whether the input data validation is successful. At step 608, if it is determined that a portion of the input data is missing, step 610 is performed. At step 610, in which input data and/or the master detail table is modified, empty fields corresponding to the missing input data are displayed to the user through user interface 106. The user is then prompted to update the missing input data. Subsequently, step 502 is repeated. Further, at step 608, input data validation also checks to determine whether an input exception report for the input data is generated. For example, the user may set threshold values for the input data through user interface 106. The input exception report displays an alert flag against the input data if the value of the input data exceeds a threshold value. Step 610 is also performed if it is determined that the value of the input data exceeds the threshold value. In this occurrence of step 610, the master detail table may be updated with input data exceeding the threshold. However, at step 608, if it is determined that the input data validation is successful, step 504 is performed.

At step 504, a set of output values to be entered in the form are determined. The output values are based on a set of business rules. Step 504 has been explained in detail in conjunction with FIG. 5. After the set of output values to be entered in the form have been determined, step 506 is performed.

Subsequently, the form is updated, at step 506. Step 506 has been explained in detail in conjunction with FIG. 5. Subsequently, the form is presented for review at step 612.

At step 612, the form is reviewed by a reviewer. The reviewer checks the validity of the output values entered in the form using the reports generated by form review module 406. In various embodiments of the present invention, validity of the output values may be checked using various reports that may include, for example, a trend-wise report of an output value, an exception-report for an output value, an input-output reconciliation report for an output value and a business rule status report. Further, the reviewer may add comments to the form through user interface 106. At step 614, it is checked whether the review of the form is successful. If it is determined that the review of the form is not successful, step 612 is performed. However, if it is determined that the review of the form is successful, step 616 is performed.

At step 616, the form is submitted for final approval. An approver performs a final check on the validity of the output values entered in the form using the reports generated by form review module 406. Further, the approver may add comments to the form through user interface 106. At step 618, it is determined whether the final approval is successful. If it is determined that the final approval is not successful, step 616 is performed. Further, in case the approval is not successful, the approver may send the form with specific errors and his comments to another user for revision. However, if it is determined that the final approval is successful, step 508 is performed.

At step 508, an electronic copy of the form is submitted, for example, over the internet to a recipient. Step 508 has been explained in detail in conjunction with FIG. 5.

### III. Exemplary Implementation

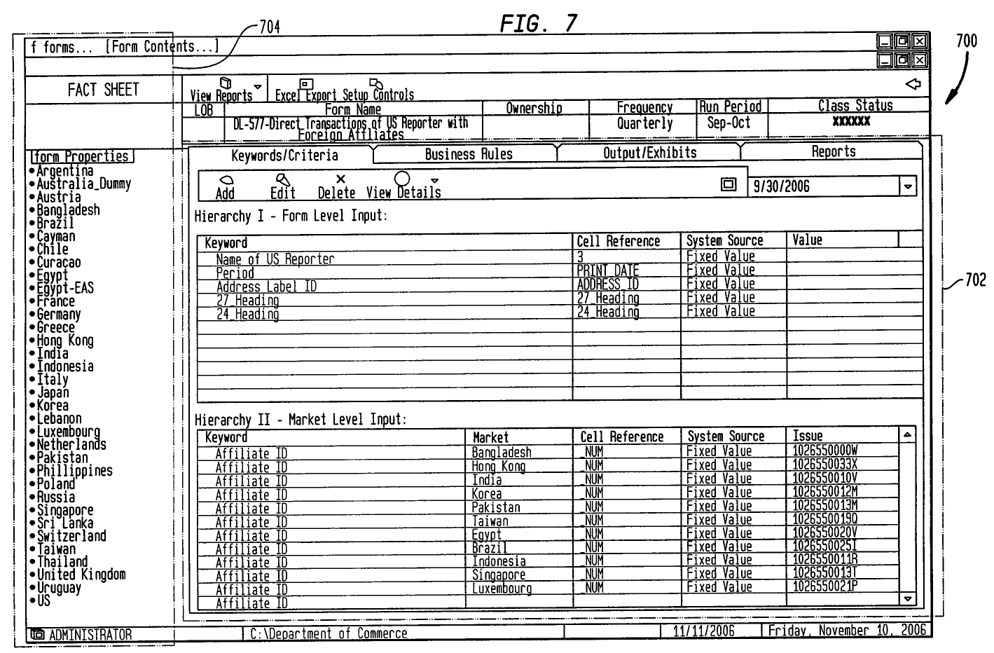

The working of various modules of automated report-generating system 100 is explained below with reference to FIGS. 7, 8, and 9, each of which is an exemplary window or screenshot of the Graphical User Interface (GUI), such as user interface 106 of automated report-generating system 100.

Referring to FIG. 7, an exemplary window or screenshot 700 generated by user interface 106 of automated report-generating system 100, in accordance with an embodiment of the present invention, is shown.

Screenshot 700 is a graphical user interface, which displays the details under various menus of automated report-generating system 100. In an embodiment of the present invention, screen shot 700 may include a section 702 having various menus and a section 704 having a market hierarchy. Section 702 may include, for example, a keyword menu, a business rule menu, an output/exhibits menu and reports menu. Details of a selected menu are displayed in section 702. Section 704 may include a list of different markets from which the input data is consolidated based on the keywords.

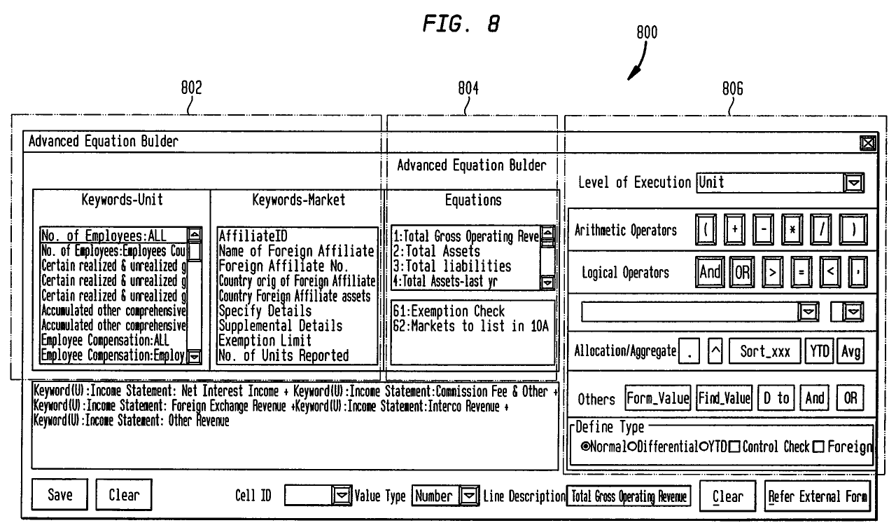

Referring to FIG. 8, an exemplary window or screenshot 800 generated by user interface 106 of automated report-generating system 100, in accordance with an embodiment of the present invention, is shown.

Screenshot 800 is a graphical user interface, which enables the user to build a business rule. In an embodiment of the present invention, screenshot 800 may include a section 802 listing a set of keywords, a section 804 listing a set of equations and a section 806 listing a set of arithmetic and logical operators. Section 802 enables the user to select the set of keywords corresponding to the input data to be entered in the set of equations. Section 804 enables the user to select the set of equations that may be used in the business rules. Section 806 enables the user to build an equation using the arithmetic and logical operators listed in the menu.

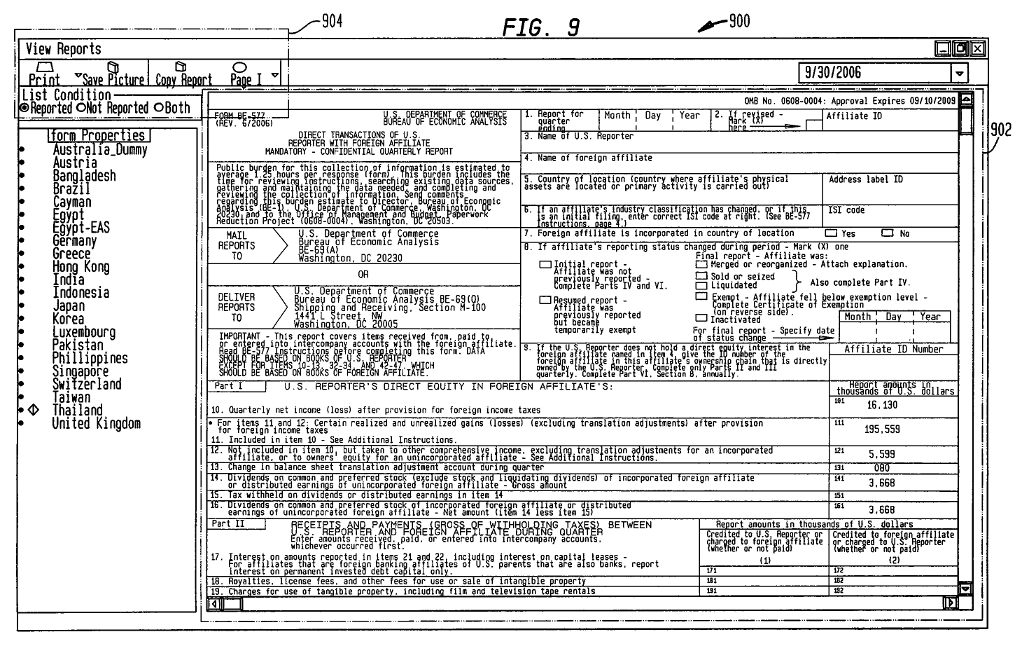

Referring to FIG. 9, an exemplary window or screenshot 900 generated by user interface 106 of automated report-generating system 100, in accordance with an embodiment of the present invention, is shown.

Screenshot 900 is a graphical user interface, which displays an exemplary form. In an embodiment of the present invention, screenshot 900 may include a section 902 displaying the form and a section 904 listing the form viewing options. Section 902 enables the user to view the form. The output values are displayed in the corresponding reportable cells of the form. Section 904 enables the user to print the form, save the form as an image file and export the form to a spreadsheet application.

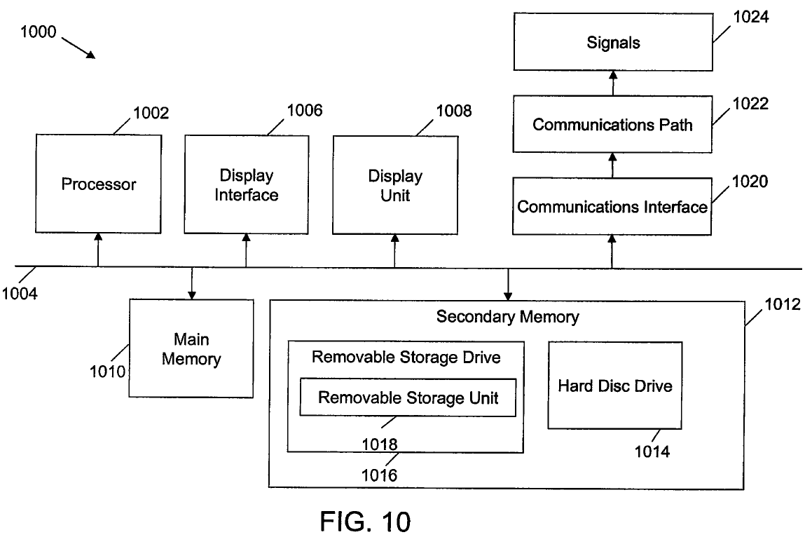

The present invention (i.e., automated report-generating system 100, process 500, process 600 or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices. An example of a computer system 1000 is shown in FIG. 10.

Computer system 1000 includes one or more processors, such as processor 1002. Processor 1002 is connected to a communication infrastructure 1004 (e.g., a communication bus, cross-over bar, or network). Various software embodiments are described in terms of this exemplary computer system. After reading this description, it will become apparent to a person skilled in the relevant art(s) how to implement the invention using other computer systems and/or architectures.

Computer system 1000 can include a display interface 1006 that forwards graphics, text, and other data from communication infrastructure 1004 (or from a frame buffer not shown) for display on a display unit 1008.

Computer system 1000 also includes a main memory 1010, preferably random access memory (RAM), and may also include a secondary memory 1012. Secondary memory 1012 may include, for example, a hard disk drive 1014 and/or a removable storage drive 1016, representing a floppy disk drive, a magnetic tape drive, an optical disk drive and the like. Removable storage drive 1016 reads from and/or writes to a removable storage unit 1018 in a well known manner. Removable storage unit 1018 represents a floppy disk, magnetic tape, optical disk and the like. which is read by and written to by removable storage drive 1016. As will be appreciated, removable storage unit 1018 includes a computer usable storage medium having stored therein computer software and/or data.

In alternative embodiments, secondary memory 1012 may include other similar devices for allowing computer programs or other instructions to be loaded into computer system 1000. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM), random access memory (RAM), or flash memory) and associated socket, and other removable storage units and interfaces, which allow software and data to be transferred from the removable storage unit to computer system 1000.

Computer system 1000 may also include a communications interface 1020. Communications interface 1020 allows software and data to be transferred between computer system 1000 and external devices. Examples of communications interface 1020 may include a modem, a network interface (such as an Ethernet card), a communications port, a Personal Computer Memory Card International Association (PCMCIA) slot and card and the like. Software and data transferred via communications interface 1020 are in the form of signals 1024 which may be electronic, electromagnetic, optical or other signals capable of being received by communications interface 1020. These signals 1024 are provided to communications interface 1020 via a communications path (e.g., channel) 1022. This communications path 1022 carries signals 1024 and may be implemented using wire or cable, fiber optics, a telephone line, a cellular link, an radio frequency (RF) link and other communications channels.

In this document, the terms ‘computer program medium’ and ‘computer usable medium’ are used to generally refer to media such as removable storage drive 1016, a hard disk installed in hard disk drive 1014, and signals 1024. These computer program products provide software to computer system 1000. The invention is directed to such computer program products.

Computer programs (also referred to as computer control logic) are stored in main memory 1010 and/or secondary memory 1012. Computer programs may also be received via communications interface 1020. Such computer programs, when executed, enable computer system 1000 to perform the features of the present invention, as discussed herein. In particular, the computer programs, when executed, enable processor 1002 to perform the features of the present invention. Accordingly, such computer programs represent controllers of computer system 1000.

In an embodiment where the invention is implemented using software, the software may be stored in a computer program product and loaded into computer system 400 using removable storage drive 1016, hard disk drive 1014 or communications interface 1020. The control logic (software), when executed by processor 1002, causes processor 1002 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### IV. CONCLUSION

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

1. An automated report-generating system comprising:
a database configured to store input data;
an input module configured to consolidate the input data;
a computation module configured to determine a set of output values based on the input data according to a predefined rule; and
an output module configured to compile at least one form with the set of output values, the at least one form being compliant with a predefined format for submission to a recipient.

2. The automated system of claim 1, wherein the input data consolidated by the input module includes at least one of: data present in external spreadsheet files, fixed values, manually-entered values, and data present in internal spreadsheet files.

3. The automated system of claim 1, wherein the input module comprises:
an input defining module configured to maintain at least one master detail table in a database;
an input updating module configured to consolidate the input data stored in the database; and
an input validation module configured to check for at least one of errors and exceptions according to parameters included in the at least one master detail table.

4. The automated system of claim 3, wherein the input updating module is further configured to consolidate the input data based on a set of keywords, wherein a keyword includes an attribute of the input data to be captured, on which further processing is to be performed to calculate the output value to be entered in the at least one form.

5. The automated system of claim 1, wherein the computation module comprises:
a rule module configured to determine the set of output values to be entered in the at least one form according to the predefined rule; and
a cell referencing module configured to reference the set of output values to corresponding reportable cells in the at least one form.

6. The automated system of claim 5, wherein the predefined rule comprises at least one of: an equation, a keyword, a predefined list of mathematical functions, or a predefined list of arithmetic and logical operators.

7. The automated system of claim 5, wherein the cell referencing module is further configured to link the set of output values to the corresponding reportable cells using a unique identification number of the predefined rule.

8. The automated system of claim 1, wherein the output module comprises:
a form updating module configured to update the at least one form based on the set of output values;
a form viewing module configured to display the at least one form having output values as requested by the recipient;
a form review module configured to enable user review of the at least one form;
a form status module configured to generate at least one report to track a status of the at least one form; and
a form submission module configured to convert the at least one form into a format that is compatible with the recipient.

9. A method for automatic report generation, comprising:
(a) consolidating input data stored in a database based on a set of keywords, wherein the input data is received from a plurality of sources;
(b) determining a set of output values to be entered in a form based on the consolidated input data according to a predefined rule;
(c) updating the form with the set of output values; and
(d) converting the form to a format compatible with a recipient.

10. The method of claim 9, further comprising at least one of: generating an electronic copy of the converted form which is compatible to the format used by the recipient of the form, printing the converted form, saving the converted form as an image file, and copying the converted form to an electronic clipboard.

11. The method of claim 9, wherein said consolidating comprises checking the input data for errors with respect to corresponding predefined parameters.

12. The method of claim 11, wherein said consolidating further comprises determining whether a portion of the input data is missing.

13. The method of claim 12, wherein said consolidating further comprises:
displaying to a user empty fields corresponding to the missing portion of the input data via a user interface; and
prompting the user to update the missing portion of the input data.

14. The method of claim 9, further comprising generating at least one report for checking the validity of the set of output values.

15. The method of claim 9, wherein said determining a set of output values comprises linking the set of output values to corresponding reportable cells in the form using unique identifiers of the predefined rule.

16. A computer program product comprising a computer usable medium having control logic stored therein for causing a computer to automatically generate reports, said control logic comprising:
first computer readable program code means for causing the computer to consolidate input data stored in a database based on a set of keywords, wherein the input data is received from a plurality of sources;
second computer readable program code means for causing the computer to determine a set of output values to be entered in a form based on the consolidated input data according to a predefined rule;
third computer readable program code means for causing the computer to update the form with the set of output values; and
fourth computer readable program code means for causing the computer to convert the form to a format compatible with a recipient.

17. The computer program product of claim 16, further comprising at least one of:
fifth computer readable program code means for causing the computer to transmit an electronic copy of the converted form to the recipient;
sixth computer readable program code means for causing the computer to print the converted form;
seventh computer readable program code means for causing the computer to save the converted form as an image file; and
eighth computer readable program code means for causing the computer to copy the converted form to an electronic clipboard.

18. The computer program product of claim 16, wherein said first computer readable program code means includes computer readable program code means for causing the computer to check the input data for at least one of errors and exceptions with respect to corresponding predefined parameters.

19. The method of claim 18, wherein said first computer readable program code means further includes computer readable program code means for causing the computer to determine whether a portion of the input data is missing.

20. The method of claim 16, wherein said second computer readable program code means includes computer readable program code means for causing the computer to link the set of output values to corresponding reportable cells in the form using unique identifiers of the predefined rule.
